(19) United States
(12) Patent Application Publication
(10) Pub. No.: US 2007/0282861 A1
(43) Pub. Date: Dec. 6, 2007

(54) Data Structure, System and Method for Event Reporting

(76) Inventors: Young-Joo Song, Daejon (KR); Jae-Gon Kim, Daejon (KR); Jin-Woo Hong, Daejon (KR); Nammee Moon, Seoul (KR); Kyunghe Ji, Seoul (KR)

Correspondence Address: LADAS & PARRY LLP, 224 SOUTH MICHIGAN AVENUE, SUITE 1600, CHICAGO, IL, 60604, US

(21) Appl. No.: 10/580,483

(22) PCT Filed: Nov. 26, 2004
(86) PCT No.: PCT/KR04/03089

§ 371 Date: Jan. 24, 2007

(30) Foreign Application Priority Data
Nov. 26, 2003 (KR) 10-2003-0084742
Apr. 14, 2004 (KR) 10-2004-0025933
Jul. 9, 2004 (KR) 10-2004-0053645
Jul. 30, 2004 (KR) 10-2004-0060502
Oct. 12, 2004 (KR) 10-2004-0081414

(51) Int. Cl. G06F 17/00

(52) U.S. Cl. 707/100

(57) ABSTRACT

Provided is a data structure for reporting an Event that occurs upon the use of a Digital Item (DI), an Event Reporting system using the data structure, and a method thereof. The Event Reporting system of the present invention for requesting and processing report on an Event that occurs upon a use of a digital item includes: an Event Report Request data processing means for creating an Event Report Request data which requests a report on an Event Report data; and an Event Report data processing means for creating and transmitting an Event request in response to the Event Report Request data transmitted from the Event Report Request data processing means to perform an Event Reporting.

### TECHNICAL FIELD

The present invention relates to a data structure for reporting of an Event that occurs upon a use of a Digital Item (DI), an Event Reporting system using the same, and a method thereof.

More particularly, the present invention relates to Event Report Request (ERR) data which are used for Event Reporting of an Event that occurs upon a use of a Digital Item (DI), a data structure of Event Report (ER) data, an Event Reporting system for managing and processing Events by using the Event Report Request data and Event Report data, a method thereof, and a computer-readable recording medium for recording a program that implements the method.

### BACKGROUND ART

Moving Picture Experts Group (MPEG) presents ‘Event Reporting (ER)’ based on the use of a Digital Item (DI), which is a new Standard Working Item (SWI) of the MPEG-21.

According to what is defined in the MPEG-21, the digital item stands for a structured digital object with a standard representation, identification and metadata.

The Event Reporting means a process of requesting a report on a particular Event that occurs when a user or a user terminal (Peer) uses a digital item, performing Event monitoring, and reporting the occurrence of an Event.

Herein, the user includes a producer, a right holder, a distributor, and a consumer.

The MPEG-21 is composed of seven major elements: Digital Item Declaration (DID), Digital Item Identification and Description (DII&D), Content Handling and Usage, Intellectual Property Management and Protection (IPMP), Terminal and Network, Content Representation, and Event Reporting.

Herein, it is the purpose of the Event Reporting to provide a standard method for measuring an Event that occurs when the digital item of the MPEG-21 is used directly or indirectly and provide interface for reporting.

The Event Reporting can be applied to digital item Usage Report, e.g., performance and copy of a digital item, Technical Report, e.g., Bandwidth Usage/Availability, Network Congestion and Load Balancing, and Financial Report, e.g., Proof of Purchase, License Purchase and Delivery.

Therefore, the Event Reporting contributes to further understanding of each user operation, provides information on creation, delivery, consumption of a digital item, and manages a distribution process by reporting copyright or an Event related to finance.

The Event Reporting is classified into Event Report Request data and Event Report data.

An Event Report Request data is a process of creating and transmitting an Event Report Request data, which is a message containing a request for reporting a particular Event that occurs when a particular digital item is used. Preferably, the Event Report Request data is metadata.

The Event Report data is a process of creating and transmitting an Event Report data containing a report when an Event specified in the transmitted Event Report Request data that occurs. The Event Report data also is metadata, preferably.

Therefore, a system in support of Event Reporting should include an apparatus for creating and transmitting an Event Report Request data upon a request from a user and an apparatus for receiving, analyzing and storing the Event Report Request data, monitoring the corresponding Event, and creating and transmitting an Event Report data for the Event occurrence.

Also, the above system requires standardized structures for an Event Report Request data and an Event Report data creating and transmitted in the system.

However, since there is no apparatus for performing Event Reporting upon the use of a digital item and no standardized structures for the Event Report Request data and the Event Report data, there is a problem that Event Reporting based on the use of a digital item is not utilized.

### DISCLOSURE

### Technical Problem

It is, therefore, an object of the present invention to provide data structures for an Event Report Request data and an Event Report data for performing Event Reporting upon a use of a Digital Item.

It is another object of the present invention to provide an Event Reporting system for processing an Event Reporting by using the Event Report Request data and Event Report data, a method thereof, and a computer-readable recording medium for recording a program that implements the method.

### Technical Solution

In accordance with one aspect of the present invention, there is provided an Event Reporting system for requesting and processing a report on an Event that occurs upon a use of a digital item, which includes: an Event Report Request data processor for creating an Event Report Request data which requests a report on an Event Report data; and an Event Report data processor for creating and transmitting an Event Report in response to the Event Report Request data transmitted from the Event Report Request data processing means to perform an Event Reporting.

In accordance with another aspect of the present invention, there is provided a method for reporting an Event that occurs upon a use of a digital item to perform Event Reporting, which includes: a) an Event Report Request data processing step of creating and transmitting an Event Report Request data requesting a report on an Event, and receiving, analyzing an Event Report Request data from outside and monitoring an Event corresponding to the Event Report Request data; and b) an Event Report data processing step of creating and transmitting the Event Report data created to perform Event Reporting corresponding to the transmitted Event Report Request data.

In accordance with another aspect of the present invention, there is provided a structure of an Event Report Request message data which is used for requesting a report on an Event that occurs upon a use of a digital item to perform Event Reporting, which includes: a Event Report Request Descriptor for describing the characteristics of the Event Report Request itself; an Event Report Descriptor for describing characteristics that an Event Report data that occurs by the current Event Report Request data should have and Event Report data; and an Event Condition Descriptor for specifying and describing conditions which becomes a standard for occurrence of an Event.

In accordance with another aspect of the present invention, there is provided a structure of an Event Report message data which is used to provide information corresponding to an Event Report Request to perform Event Reporting on an Event that occurs upon a use of a digital item, which includes: an Event Report Descriptor for describing information related to creation and transmission of the Event Report itself; an Original Event Report Request data for describing a reference for the Event Report Request which makes the Event Report created; and an Event Report Data including a payload that report information of the Event Report data.

In accordance with another aspect of the present invention, there is provided a computer-readable recording medium for recording a program that implements an Event Reporting method in a system for requesting and processing a report on an Event that occurs upon a use of a digital item, the method including the steps of: a) an Event Report Request data processing step of creating and transmitting an Event Report Request data requesting a report on an Event, and receiving, analyzing an Event Report Request data from outside and monitoring an Event corresponding to the Event Report Request data; and b) an Event Report data processing step of creating and transmitting the Event Report data created to perform Event Reporting corresponding to the transmitted Event Report Request data.

### ADVANTAGEOUS EFFECTS

The present invention can standardize data structures of an Event Report Request and an Event Report and utilize Event Reporting by providing data structures for Event Reporting upon a use of a digital item.

Also, the present invention utilizes Event Reporting based on the use of a digital item by providing a system and method for Event Reporting.

Also, the present invention can increase understanding of each user operation of MPEG-21, manage data on a process of creating, delivering and consuming a digital item, and manage a copyright or a distribution process through finance-related Event Reporting.

### DESCRIPTION OF DRAWINGS

FIG. 1 is a block diagram illustrating an Event Reporting system in accordance with an embodiment of the present invention;

FIG. 2 is a block diagram showing an Event Report Request (ERR) data in accordance with an embodiment of the present invention;

FIG. 3 is a detailed block diagram describing a descriptor of an Event Report Request data in accordance with an embodiment of the present invention;

FIG. 4 is a diagram describing lifetime of an Event Report Request descriptor in accordance with an embodiment of the present invention;

FIG. 5 is a detailed diagram illustrating a history of an Event Report Request data in accordance with an embodiment of the present invention;

FIG. 6 is a diagram describing a priority of an Event Report Request data in accordance with an embodiment of the present invention;

FIG. 7 is a detailed diagram showing an Event Report (ER) data of an Event Report Request data in accordance with an embodiment of the present invention;

FIG. 8 is a diagram describing “DeliveryParams” of an Event Report Request data in accordance with an embodiment of the present invention;

FIG. 9 is a diagram describing a delivery time (DeliverTime) of an Event Report Request data in accordance with an embodiment of the present invention;

FIG. 10 is a diagram illustrating a time type (TimeType) which is used for representing the delivery time (DeliverTime) of an Event Report Request data in accordance with an embodiment of the present invention;

FIG. 11 is a diagram describing an Event condition descriptor (EventConditionDescriptor) of an Event Report Request data in accordance with an embodiment of the present invention;

FIG. 12 is a diagram illustrating a time condition (Time Condition) of an Event Report Request data in accordance with an embodiment of the present invention; and

FIG. 13 is a diagram showing an Event Report data in accordance with an embodiment of the present invention.

### BEST MODE FOR THE INVENTION

Other objects and aspects of the invention will become apparent from the following description of the embodiments with reference to the accompanying drawings, which is set forth herein after.

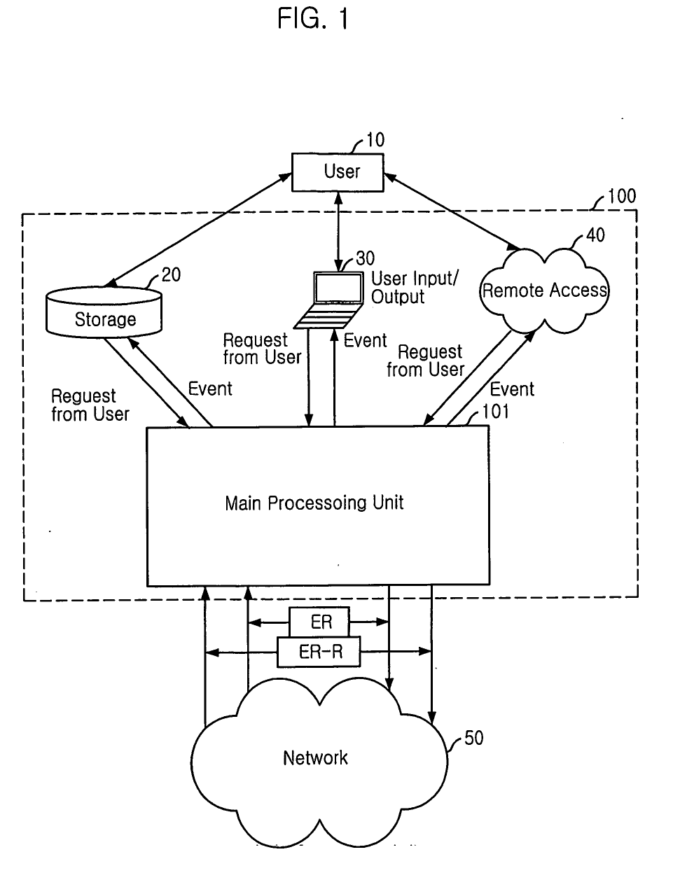

FIG. 1 is a block diagram illustrating an Event Reporting system in accordance with an embodiment of the present invention.

As illustrated in FIG. 1, the Event Reporting system 100 of the present invention includes a main processing 101 which is in charge of substantial Event Reporting process. The main processing 101 communicates with a user 10 in a form of a file through a direct input/output interface 30 or a particular storage 20 of the user 10 or in a form of remote access 40 through a network. Also, the Event Reporting system 100 communicates with an external user through a network 50 and transmits or receives an Event Report (ER) data or an Event Report Request (ERR) data.

Herein, the Event Report Request data is data describing what to report, to whom to report, a form of report, when to report and how to report, when an Event occurs with respect to a digital item. Further description on it will be provided later.

The Event Report data specifies information related to an Event requested in the Event Report Request data. It describes from whom the report is requested and to whom to deliver the report. Further description on it will be provided later, too.

The Event Reporting system 100 can be mounted on a laptop computer, a desktop computer, workstation, mainframe, and other types of computers, and it can be also mounted on all systems where a digital item (DI) is created, delivered, and consumed, such as a Personal Digital Assistant (PDA) and a mobile communication station.

The user 10 can directly access to the above-mentioned systems and request the Event Reporting system 100 to create Event Report data requests one by one through a direct input procedure into an application program.

Also, the user 10 can request the Event Reporting system 100 to create an Event Report Request data by storing what is requested in the storage 20 in advance.

Herein, the storage 20 can be positioned in and out of the Event Reporting system 100 and it includes all types of storing media, e.g., a CD-ROM, RAM, floppy disks, hard disks, and magneto-optical disks.

Also, the user 10 accesses to the Event Reporting system 100 through the network 50 at a remote place and requests it to generate an Event Report Request data.

The Event Reporting system 100 receives the request for creating an Event Report Request data from the user 10 by using the above described method, creates the Event Report Request data, and transmits the created Event Report-Request data to the user 10 through the network 50.

Herein, the network 50 is formed of wired/wireless Local Area Networks (LANs), e.g., an Ethernet, a fiber distributed data interface (FDDI), a Token Ring and an Asynchronous Transfer Mode (ATM), and Wide Area Networks (WAN), e.g., Public Switched Telephone Network (PSTN), Packet Switched Data Network (PSDN) and Integrated Services Digital Network (ISDN).

The Event Reporting system 100 can receive an Event Report Request data or an Event Report data from the outside through the network 50, analyze it, create another Event Report Request data or another Event Report data, and transmit the Event Report Request data or Event Report data to outside. It can extract information contained in the Event Report Request data or Event Report data and store or transmit the information directly to a user application program.

Herein, the Event Report Request data and the Event Report data will be described in detail.

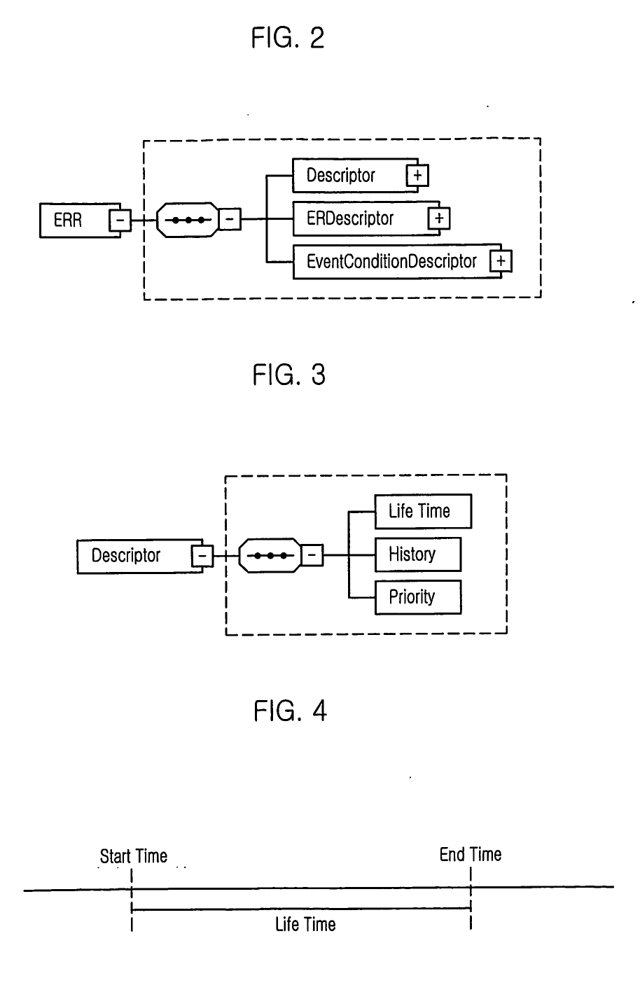

FIG. 2 is a block diagram showing an Event Report Request data in accordance with an embodiment of the present invention.

As described in FIG. 2, the Event Report Request data includes a descriptor for describing ERR instance, an Event Report descriptor (ERDiscriptor) for describing characteristics and data that an ER message to be generated for the current Event Report Request data, and an Event condition descriptor (EventConditionDescriptor) for specifying and describing conditions that become a standard for occurrence of an Event.

Hereafter, elements of the Event Report Request data will be described with reference to related drawings.

FIG. 3 is a detailed block diagram describing a descriptor of an Event Report Request data in accordance with an embodiment of the present invention.

As shown in FIG. 3, the ERR descriptor of the present invention includes life time (LifeTime) which indicates the remaining life time of the Event Report Request data, history (History) for describing information on history of the occurrence or modification of an Event Report Request data and an Event Report data.

The elements of the Event Report Request descriptor (Descriptor) will be described more in detail, hereafter.

After the specified life time (LifeTime) is passed, the Event Report Request data is not valid any more. Also, the history (History) can be applied to both Event Report Request data modification history and Event Report data modification history, Priority level can be applied to both ERR and ER also, and an Event Report Request data having a higher priority is processed first.

The following eXtensible Markup Language (XML) syntax defines a descriptor (Descriptor) of an Event Report Request data in accordance with an embodiment of the present invention.

```
<!-- ######################################## -->
<!--  Definition of ERR Descriptor  ->
<!-- ######################################## -->
<xsd:element name=“Descriptor”>
<xsd:complexType>
  <xsd:sequence>
    <xsd:element name=“LifeTime” type=“erl:ERTimeType”
minOccurs=“0” maxOccurs=“1”/>
    <xsd:element name=“History” type=“erl:HistoryType”
minOccurs=“0” maxOccurs=“1”/>
    <xsd:element name=“Priority” type=“erl:PriorityLevelType”
minOccurs=“0” maxOccurs=“1” default=“2”/>
  </xsd:sequence>
</xsd:complexType>
</xsd:element>
```

FIG. 4 is a diagram describing lifetime of an ERR descriptor in accordance with an embodiment of the present invention.

As illustrated in FIG. 4, life time (LifeTime) which defines the remaining life time (i.e., life time of validity) of the Event Report Request data that occurs currently includes a definite starting time (StartTime) of the valid life time and a definite end time (EndTime) of the valid life time.

The following XML syntax defines life time (LifeTime) of an Event Report Request data in accordance with an embodiment of the present invention.

```
<!-- ########################################## -->
<!--  Definition of ERRLifeTime datatype  -->
<!-- ########################################## -->
<xsd:element name=“LifeTime”>
    <xsd:complexType>
        <xsd:sequence>
            <xsd:element name=“StartTime” type=“xsd:dateTime” />
            <xsd:element name=“EndTime” type=“xsd:dateTime” />
        </xsd:sequence>
    </xsd:complexType>
</xsd:element>
```

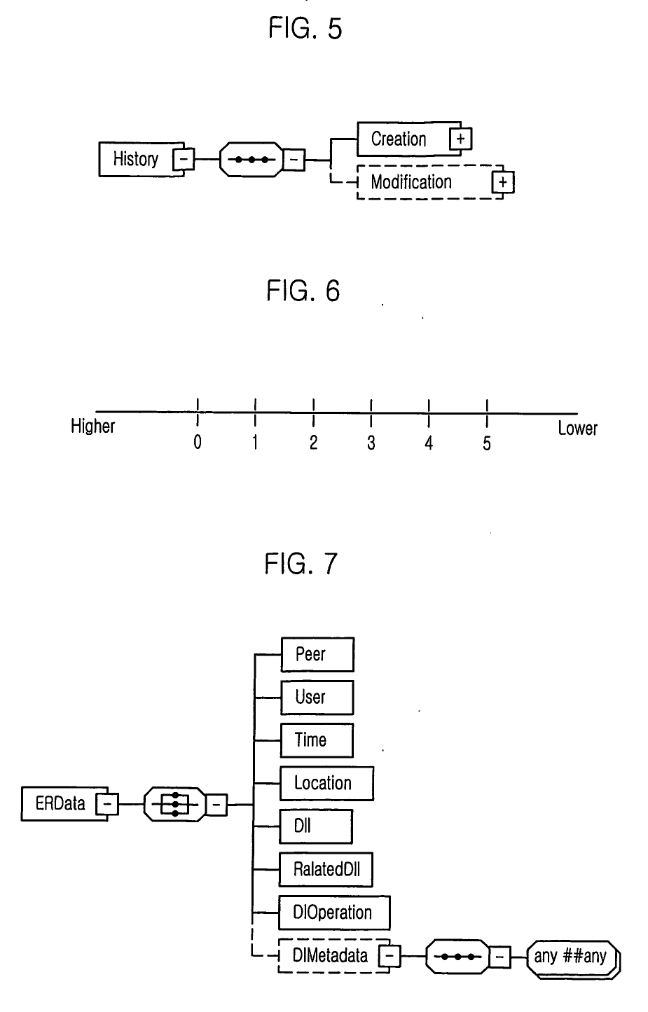

FIG. 5 is a detailed diagram illustrating a history of an Event Report Request data in accordance with an embodiment of the present invention.

As illustrated in FIG. 5, the history (History) of an Event Report Request data of the present invention includes creation information (Creation) and modification information (Modification). Herein, the modification information (Modification) has a frequency number of 0 to infinity.

The following XML syntax defines history (History) of an Event Report Request data in accordance with an embodiment of the present invention.

```
<!-- ########################################## -->
<!--  Definition of History datatype  -->
<!-- ########################################## -->
<xsd:element name=“History” minOccur=“1”>
  <xsd:complexType>
    <xsd:sequence>
    <xsd:element name=“Creation” type=“CreationType” minOccur=“1”/>
    <xsd:element name=“Modification” type=“ModificationType” minOccurs=“0”
maxOccurs=“unbounded”/>
    </xsd:sequence>
  </xsd:complexType>
</xsd:element>
<xsd:complexType name=“CreationType”>
  <xsd:sequence>
    <xsd:element name=“Peer” type=“xsd:anyURI”/>
    <xsd:element name=“User” type=“xsd:anyURI”/>
    <xsd:element name=“Time” type=“xsd:dateTime”/>
    <xsd:element name=“Description” type=“xsd:string” minOccurs=“0”/>
  </xsd:sequence>
</xsd:complexType>
<xsd:complexType name=“ModificationType”>
  <xsd:sequence>
    <xsd:element name=“Action”>
    <xsd:simpleType>
      <xsd:restriction base=“xsd:NMTOKEN ANYURI”>
      <xsd:enumeration value=“RDD:mpeg:mpeg21:Modify”/>
      </xsd:restriction>
    </xsd:simpleType>
    </xsd:element>
    <xsd:element name=“Peer” type=“xsd:anyURI”/>
    <xsd:element name=“User” type=“xsd:anyURI”/>
    <xsd:element name=“Time” type=“xsd:dateTime”/>
    <xsd:element name=“Description” type=“xsd:string” minOccurs=“0”/>
  </xsd:sequence>
</xsd:complexType>
```

Parameters (NAME) used in the XML syntax of the history (History) of the Event Report Request data have the following meaning.

A parameter “CreationType” denotes information on the generation of instance of the Event Report Request data and the Event Report data, while a parameter “ModificationType” provides information on modification of instance of the Event Report Request data and the Event Report data.

Also, a parameter “Peer” is a unique identifier of a peer that has performed creation and modification, while a parameter “User” is a unique identifier of a user that has performed creation and modification.

Also, a parameter “Time” is time when the instance of the Event Report Request data and the Event Report data is created or modified, while a parameter “Description” indicates operation of a peer that has generated or modified the instance of the Event Report Request data and the Event Report data.

FIG. 6 is a diagram describing a priority of an Event Report Request data in accordance with an embodiment of the present invention.

As shown in FIG. 6, the priority of an Event Report Request data, which is an order for processing Event Report Request data, has a value from 0 to 5. The smaller the number is, the higher the priority level is.

The following XML syntax defines priority of an Event Report Request data in accordance with an embodiment of the present invention.

```
<!-- ########################################## -->
<!--  Definition of PriorityLevel datatype  -->
<!-- ########################################## -->
<xsd:simpleElement name=“Priority”>
    <xsd:restriction base=“xsd:string”>
        <xsd:enumeration value=“0”/>
        <xsd:enumeration value=“1”/>
        <xsd:enumeration value=“2”/>
        <xsd:enumeration value=“3”/>
        <xsd:enumeration value=“4”/>
        <xsd:enumeration value=“5”/>
    </xsd:restriction>
</xsd:simpleElement>
```

Hereinafter, an Event Report descriptor (ERDiscriptor) of an Event Report Request data will be described in accordance with an embodiment of the present invention.

```
<!-- ######################################## -->
<!--  Definition of Event Report Descriptor  -->
<!-- ######################################## -->
<xsd:element name=“ERDescriptor”>
<xsd:complexType>
  <xsd:sequence>
    <xsd:element name=“ERIdentifier” type=“dii:Identifier”
minOccurs=“0”/>
    <xsd:element name=“ERDescription” type=“xsd:string”
minOccurs=“0”/>
    <xsd:element name=”ERAccessControl” type=”xsd:anyType”/>
    <xsd:element name=“ERData” type=“erl:ReportData”/>
    <xsd:element name=“ERFormat” type=“erl:ReportFormat”/>
    <xsd:element name=“EmbeddedERR” type=“erl:EmbeddedERRType”
minOccurs=“0”/>
    <xsd:element name=“DeliveryParams”
type=“erl:DeliveryParmasType”/>
  </xsd:sequence>
</xsd:complexType>
</xsd:element>
```

The meanings of significant parameters (NAME) used in the XML syntax of the Event Report descriptor (ERDiscriptor) of the Event Report Request data are as follows.

A parameter “ERID” is a unique identifier of an Event Report data to be created, while a parameter “ERAccessControl” describes information of a peer or a user that can access to the Event Report data.

Also, a parameter “ERData,” which is an element that specifies an Event Report data requested by an Event Report Request data, can be the report requested by a sub-element such as a peer, a user, and reference digital items (RefDI).

A parameter “ERFormat” indicates a request format of an Event Report data (ERData), while a parameter “EmbeddedERR” describes another Event Report Request data to be added to the Event Report Request data. A parameter “DeliveryParams” specifies a receiver, delivery time, a delivery method for the delivery of the Event Report data.

FIG. 7 is a detailed diagram showing Event Report data of an Event Report Request data in accordance with an embodiment of the present invention.

As illustrated in FIG. 7, an Event Report data (ERData) of an Event Report Request data, which is an element that specifies report data requested by an Event Report Request data, includes parameters “Peer,” “User,” “Time,” “Location,” “DII,” “RdlatedDII” and “DIOperation” and additionally includes a parameter “DIMetadata”

The following XML syntax defines Event Report data (ERData) of an Event Report Request data in accordance with an embodiment of the present invention.

```
<xsd:element name=“ERData”>
  <xsd:complexType>
    <xsd:all>
    <xsd:element name=“Peer”>
      <xsd:complexType>
      <xsd:attribute name=“optional” type=“xsd:boolean”
default=“false”/>
      </xsd:complexType>
    </xsd:element>
    <xsd:element name=“User”>
      <xsd:complexType>
      <xsd:attribute name=“optional” type=“xsd:boolean”
default=“false”/>
      </xsd:complexType>
    </xsd:element>
    <xsd:element name=“Time”>
      <xsd:complexType>
      <xsd:attribute name=“optional” type=“xsd:boolean”
default=“false”/>
      </xsd:complexType>
    </xsd:element>
    <xsd:element name=“Location”>
      <xsd:complexType>
      <xsd:attribute name=“optional” type=“xsd:boolean”
default=“false”/>
      </xsd:complexType>
    </xsd:element>
    <xsd:element name=“DII”>
      <xsd:complexType>
      <xsd:attribute name=“optional” type=“xsd:boolean”
default=“false”/>
      </xsd:complexType>
    </xsd:element>
    <xsd:element name=“RelatedDII”>
      <xsd:complexType>
      <xsd:attribute name=“optional” type=“xsd:boolean”
default=“false”/>
      </xsd:complexType>
    </xsd:element>
    <xsd:element name=“DIOperation”>
      <xsd:complexType>
      <xsd:attribute name=“optional” type=“xsd:boolean”
default=“false”/>
      </xsd:complexType>
    </xsd:element>
    <xsd:element name=“DIMetadata” minOccurs=“0”>
      <xsd:complexType>
      <xsd:sequence>
        <xsd:any namespace=“##any” processContents=“lax”
maxOccurs=“unbounded”/>
      </xsd:sequence>
      </xsd:complexType>
    </xsd:element>
    </xsd:all>
  </xsd:complexType>
</xsd:element>
```

The meanings of significant parameters (NAME) used in the XML syntax of the Event Report data (ERData) of the Event Report Request data are as follows.

A parameter “PeerId” is a unique identifier of a peer that generates an Event Report data, while a parameter “UserId” is a unique identifier of a user that creates an Event Report data. A parameter “Time” is time when the Event occurs and a parameter “Location” is location information of the peer.

Also, a parameter “DII” is a digital item identifier, which is an object of Event occurrence, while a parameter “Related DII” is a digital item identifier related with the present Event Report data. A parameter “DIOperation” is an operation related with a user of a digital item, and a parameter “DIMetadata” is a report requested other than the items described above.

The following XML syntax defines the parameter “EmbeddedERR” in accordance with an embodiment of the present invention.

```
    <!-- ######################################## -->
    <!--  Definition of EmbeddedERR  -->
    <!-- ######################################## -->
    <xsd:element name=“EmbeddedERR”>
        <xsd:complexType>
            <xsd:choice maxOccurs=“unbounded”>
                <xsd:element ref=“erl:ERR”/>
                <xsd:element name=“ERRReference”
type=“xsd:IDREF”/>
            </xsd:choice>
        </xsd:complexType>
    </xsd:element>
```

The Event Report Request data of the present invention can be enclosed in another Event Report Request data or another Event Report data for the purpose of acknowledgement or forwarding. The parameter “EmbeddedERR” is the Event Report Request data enclosed in the Event Report Request data.

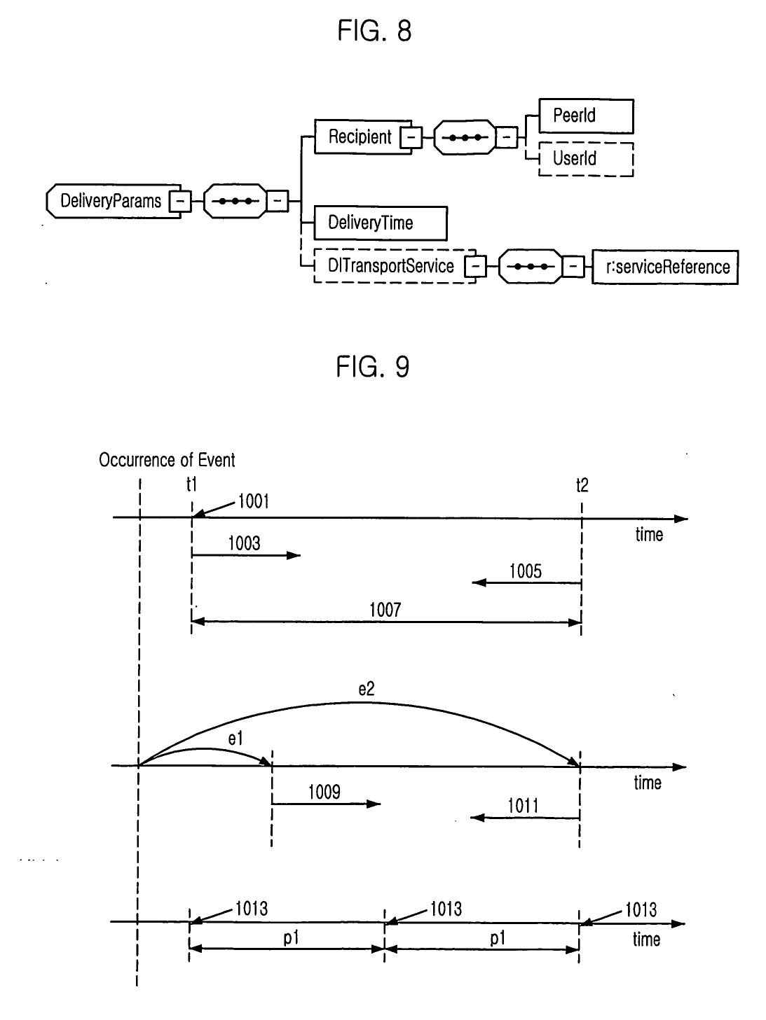

FIG. 8 is a diagram describing “DeliveryParams” of an Event Report Request data in accordance with an embodiment of the present invention.

As shown in FIG. 8, a parameter “DeliveryParams” of an Event Report Request data of the present invention includes elements needed for transmission of an Event Report data that occurs. Among the elements are a recipient (Recipient) of the Event Report data, delivery time (DeliveryTime) of the Event Report data, and a transport service reference (DITransportService).

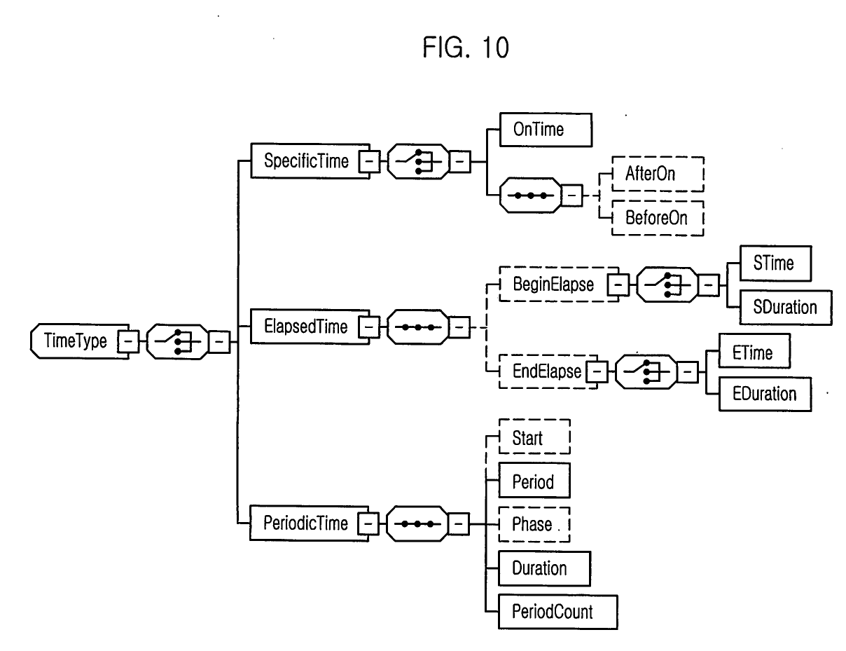

FIG. 9 is a diagram describing a delivery time (DeliverTime) of an Event Report Request data in accordance with an embodiment of the present invention, and FIG. 10 is a diagram illustrating a type of time (TimeType) which is used for representing the delivery time (DeliverTime) of an Event Report Request data in accordance with an embodiment of the present invention.

The delivery time (DeliverTime) of the Event Report Request data can have the case of FIG. 9 based on an Event occurrence time.

The following XML syntax defines the parameter “DeliveryParams” of an Event Report Request data in accordance with an embodiment of the present invention.

```
<!-- ############################################ -->
<!--  Definition of Delivery Attribute  -->
<!-- ############################################ -->
<xsd:complexType name=“DeliveryParams”>
<xsd:sequence>
  <xsd:element name=“Recipient”/>
  <xsd:element name=“DeliveryTime” type=“erl:TimeType”/>
  <xsd:element name=“DITransportService” minOccurs=“0”>
    <xsd:complexType>
      <xsd:sequence>
      <xsd:element ref=“r:serviceReference”/>
      </xsd:sequence>
    </xsd:complexType>
  </xsd:element>
</xsd:sequence>
</xsd:complexType>
<xsd:element name=“Recipient” >
<xsd:complexType>
    <xsd:sequence minOccurs=“1” maxOccurs=“unbounded”>
    <xsd:element name=“PeerId” type=“xsd:anyURI” minOccurs=“1” maxOccurs=“1” />
    <xsd:element name=“UuserId” type=“xsd:anyURI” minOccurs=“0”/>
    </xsd:sequence>
  </xsd:complexType>
</xsd:element>
<xsd:complexType=“TimeType”>
  <xsd:choice minOccurs=“0”>
    <xsd:element name=“SpecificTime” type=“SpecificTime”/>
    <xsd:element name=“ElapsedTime” type=“ElapsedTime”/>
    <xsd:element name=“PeriodicTime” type=“PeriodicTime”/>
  </xsd:choice>
</xsd:complexType>
<xsd:complexType name=“SpecificTime”>
<xsd:choice>
  <xsd:element name=“onTime” type=“xsd:dateTime”/>
  <xsd:sequence>
    <xsd:element name=“afterOn” type=“xsd:dateTime” minOccurs=“0”/>
    <xsd:element name=“beforeOn” type=“xsd:dateTime” minOccurs=“0”/>
  </xsd:sequence>
</xsd:choice>
</xsd:complexType>
<xsd:complexType name=“ElapsedTime”>
<xsd:sequence>
  <xsd:element name=“beginElapse” type=“BeginElapse” minOccurs=“0”/>
  <xsd:element name=“endElapse” type=“EndElapse” minOccurs=“0”/>
</xsd:sequence>
</xsd:complexType>
<xsd:complexType name=“BeginElapse”>
<xsd:choice>
  <xsd:element name=“sTime” type=“xsd:time”/>
  <xsd:element name=“sDuration” type=“xsd:duration”/>
</xsd:choice>
</xsd:complexType>
<xsd:complexType name=“EndElapse”>
<xsd:choice>
  <xsd:element name=“eTime” type=“xsd:time”/>
  <xsd:element name=“eDuration” type=“xsd:duration”/>
</xsd:choice>
</xsd:complexType>
<xsd:complexType name=“PeriodicTime”>
  <xsd:sequence>
    <xsd:element name=“Start” type=“xsd:dateTime”/>
    <xsd:element name=“DayofWeek” type=“DayofWeekType” minOccurs=“0”/>
    <xsd:element name=“Period” type=“xsd:duration”/>
    <xsd:element name=“Duration” type=“xsd:duration”/>
    <xsd:element name=“End” type=“xsd:dateTime”/>
  </xsd:sequence>
</xsd:complexType>
<!-- Definition of DayofWeekType datatype -->
<xsd:simpleType name=“DayofWeekType”>
<xsd:restriction base=“xsd:string”>
  <xsd:pattern value=“ [symbol] -?[1-5]{1}W[1-7]{1}D” />
</xsd:restriction>
</xsd:simpleType>
```

The meanings of significant parameters (NAME) used in the above XML syntax are as follows. A parameter “Recipient” is a receiving part of an Event Report data to be delivered, and a parameter “DeliveryTime” is time when the Event Report data is authored and delivered.

A parameter “SpecificTime” indicates a particular time, and a parameter “DurationTime” also indicates a particular time. A parameter “PeriodicTime” indicates a periodic transport time, and a parameter “on Time” means on-time delivery at a particular time. A parameter “afterOn” is a delivery after a particular time, and a parameter “beforeOn” means a delivery before a particular time.

A parameter “beginDuration” is a starting time point of a specific time, and a parameter “endDuration” is an ending time point of the specific time. A parameter “Start” is a starting time of a periodic transfer.

A parameter “DayofWeek” is a field for specifying a day of a week, and a parameter “Period” is interval of a week period. A parameter “Duration” is time in which a period is continued, and a parameter “End” is an end time for periodic transport.

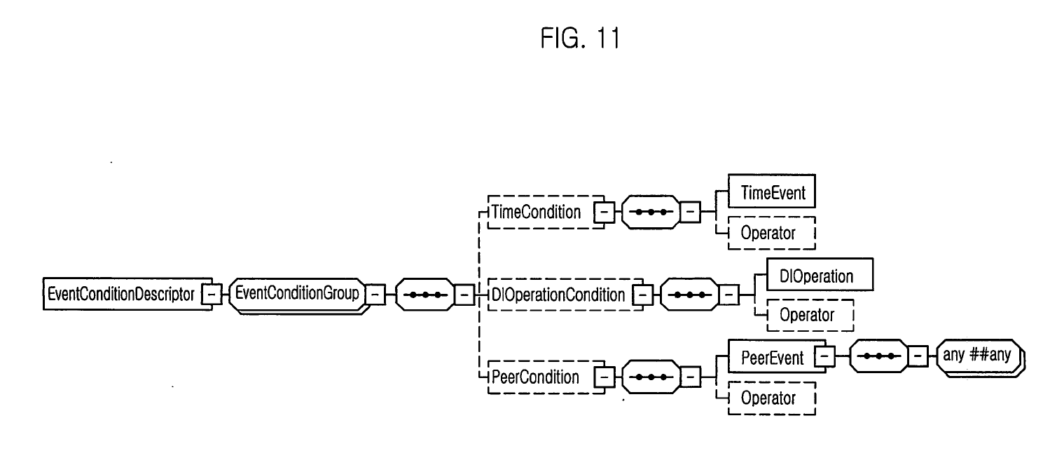

FIG. 11 is a diagram describing an Event condition descriptor (EventConditionDescriptor) of an Event Report Request data in accordance with an embodiment of the present invention.

As illustrated in FIG. 11, an Event condition descriptor (EventConditionDescriptor) of an Event Report Request data of the present invention is largely divided into three groups, and an Event condition is represented by a combination of three condition cases, i.e., a combination of parameters “TimeCondition,” “DIoperationCondition,” and “PeerCondition.”

Hereafter, the parameters “TimeCondition,” “DIoperationCondition,” and “PeerCondition” will be described, individually.

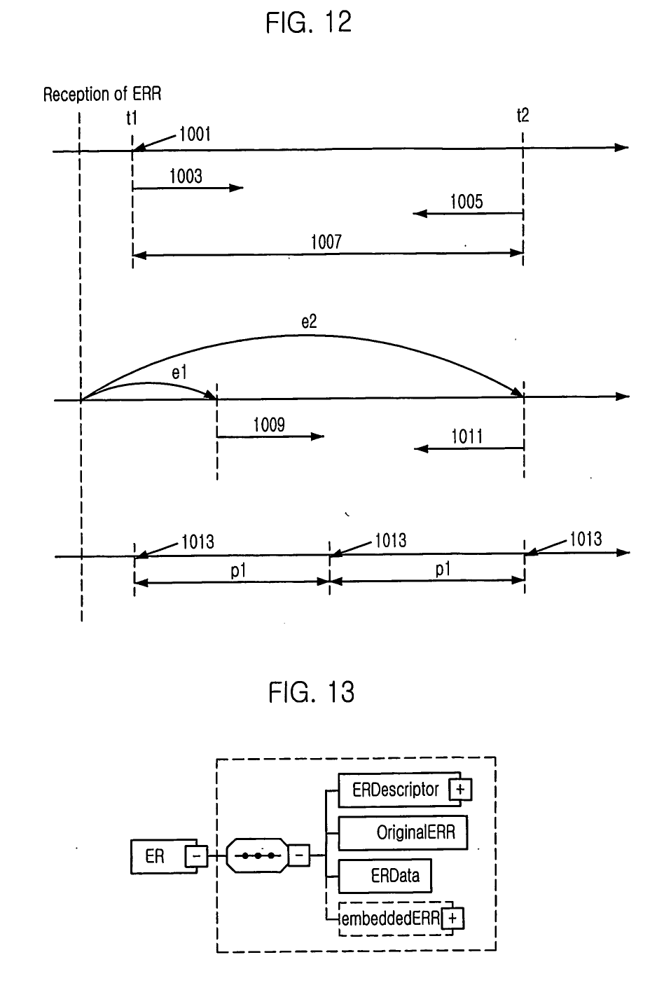

FIG. 12 is a diagram illustrating time condition (Time Condition) of an Event Report Request data in accordance with an embodiment of the present invention.

As shown in FIG. 12, the parameter “TimeCondition” includes “specific time,” “elapsed time,” and “periodic time” types based on the time when the Event Report Request data is received according to the time on the peer's part where the Event occurs. The grammar and XML description on it are as described above.

Meanwhile, the parameter “DIOperationCondition” describes an Event that occurs in relation with the use of a digital item, and it uses terms defined in ISO/IEC 21000-6 Rights Data Dictionary (RDD), e.g., play, stop, delete and move of a digital item.

Also, a parameter “PeerCondition” describes an Event that occurs regardless of the use of a digital item, and the objects of the parameter “PeerCondition” can be operation or device status of the peer.

The above-described three conditions can be combined as follows:

$$\begin{matrix}( TimeCondition ) op 1 ( DIOperationCondition ) op 1 ( PeerCondition ) ) += \\ ( ( TimeEvent , op 1 ) ? ( DIOperationCondition , op 1 ) ? \\ ( PeerCondition , op 1 ) ? ) += ( ( TimeEvent , ( operation kind , \\ location ) *) ? , ( DIOperationEvent , , ( operation kind , \\ location ) *) ? , ( PeerEvent , ( operation kind , location ) *) ? ) += \\ ( ( TimeEvent , ( operation kind , location ) *) ? , \\ ( DIOperationEvent , , ( operation kind , location ) *) ? , \\ ( ( \#\# any , op 2 ) , ( operation kind , location ) *) ? ) += \\ ( ( TimeEvent , ( operation kind 1 , location ) *) ? , \\ ( DIOperationEvent , , ( operation kind 1 , \\ location ) *) ? , ( ( \#\# any , ( operation kind 2 location ) , \\ ( operation kind 1 , location ) *) ? ) +\end{matrix}$$

wherein “op1=(operation kind 1, location)” is an operator between Event conditions (Event Condition) and “op2=(operation kind 2, location)” is an operator in an Event condition (Event Condition).

Grammar description and XML description corresponding to the regular expression will be described later when a parameter “EventConditionDescriptor” is described.

The combinations of the three conditions will be described hereafter by taking examples.
An Event condition description of an Event Report Request data requesting to author an Event Report data, if DI001 is played, can be combined as: (PLAY,DI001)
An Event condition description of an Event Report Request data requesting to author an Event Report data, if a user YJSONG plays DI001, can be combined as: (PLAY,DI1001) ((User,YJSONG(‘=’INFIX)), (AND,PREFIX))
An Event condition description of an Event Report Request data requesting to author an Event Report data, if a user YJSONG plays DI001 on Nov. 19, 2004, can be combined as: ((2004-11-19) (PLAY,DI001), (AND,PREFIX)) ((User, YJSONG (‘=’INFIX)), (AND,PREFIX))
An Event condition description within an Event Report Request data requesting to author an Event Report data, if DI001 is played on Nov. 19, 2004, or the user is YJSONG, can be combined as: ((2004-11-19, (‘(PREFIX))(PLAY,DI001, (AND,PREFIX), (‘)’POSTFIX))((User,YJSONG(‘=’INFIX)), (OR,PREFIX))
An Event condition description within an Event Report Request data requesting to author an Event Report data, if YJSONG plays DI001, or if KHJEE plays DI001, can be combined as: (PLAY,DI001 (AND,POSTFIX))((User,YJSONG (‘=’INFIX)), (‘(‘(PREFIX))((User,KHJEE(‘=’INFIX)), ((OR,PREFIX), (‘)’POSTFIX))

The following Tables 1 and 2 show external operators and internal operators. In the present invention, the operators are used for relationship between Event conditions and operation within an Event. The operators are preferred to be prefix rather than to be postfix based on condition.

TABLE 1

| | |
|---|---|
| Logical Operator | AND, OR, XOR, NOT |
| Parentheses | (,) |
| Location | PREFIX, POSTFIX |

Herein, the location in Table 1 means that the operators are located in front of or behind an Event condition.

TABLE 2

| | |
|---|---|
| Comparison Operator | =, <, >, <=, <>, >,, <= |
| Arithmetic Operator | +, −, *, /, %, \hat{ } |
| Location | PREFIX, INFIX, POSTFIX |

Herein, the location in Table 2 means that the operators are located in front of or behind a peer condition, or between the peer condition and a value.

The following XML syntax defines an Event condition descriptor (EventConditionDescriptor) of an Event Report Request data in accordance with an embodiment of the present invention.

```
<!-- ############################################# -->
<!--  Definition of Event Condition Descriptor  -->
<!-- ############################################# -->
<xsd:element name=“EventConditionDescriptor”>
  <xsd:complexType>
    <xsd:group ref=“EventConditionGroup” maxOccurs=“unbounded”/>
  </xsd:complexType>
</xsd:element>
<xsd:group name=“EventConditionGroup”>
  <xsd:sequence>
    <xsd:element name=“TimeCondition” minOccurs=“0”>
    <xsd:complexType>
      <xsd:sequence>
      <xsd:element name=“TimeEvent” type=“erl:TimeType”/>
      <xsd:element name=“Operator” minOccurs=“0”>
        <xsd:complexType>
        <xsd:attributeGroup ref=“ExternalAttrGroup”/>
        </xsd:complexType>
      </xsd:element>
      </xsd:sequence>
    </xsd:complexType>
    </xsd:element>
    <xsd:element name=“DIOperationCondition” minOccurs=“0”>
    <xsd:complexType>
      <xsd:sequence>
      <xsd:element name=“DIOperation” type=“xsd:string”/>
      <xsd:element name=“Operator” minOccurs=“0”>
        <xsd:complexType>
        <xsd:attributeGroup ref=“ExternalAttrGroup”/>
        </xsd:complexType>
        </xsd:element>
      </xsd:sequence>
    </xsd:complexType>
    </xsd:element>
    <xsd:element name=“PeerCondition” minOccurs=“0”>
    <xsd:complexType>
      <xsd:sequence>
      <xsd:element name=“PeerEvent”>
      <xsd:complexType>
        <xsd:sequence>
          <xsd:any namespace=“##any” processContents=“lax”
maxOccurs=“unbounded”/>
        </xsd:sequence>
        <xsd:attribute ref=“InternalOperator”/>
        </xsd:complexType>
      </xsd:element>
      <xsd:element name=“Operator” minOccurs=“0”>
        <xsd:complexType>
        <xsd:attributeGroup ref=“ExternalAttrGroup”/>
        </xsd:complexType>
      </xsd:element>
      </xsd:sequence>
    </xsd:complexType>
    </xsd:element>
  </xsd:sequence>
</xsd:group>
<xsd:attributeGroup name=“ExternalAttrGroup”>
  <xsd:attribute name=“kind” type=“ExternalOprType”/>
  <xsd:attribute name=“location” type=“ExternalOprLocationType”/>
</xsd:attributeGroup>
<xsd:simpleType name=“ExternalOprType”>
  <xsd:restriction base=“xsd:string”>
    <xsd:enumeration value=“AND”/>
    <xsd:enumeration value=“OR”/>
    <xsd:enumeration value=“NOT”/>
    <xsd:enumeration value=“(”/>
    <xsd:enumeration value=“)”/>
  </xsd:restriction>
</xsd:simpleType>
<xsd:simpleType name=“ExternalOprLocationType”>
  <xsd:restriction base=“xsd:string”>
    <xsd:enumeration value=“prefix”/>
    <xsd:enumeration value=“postfix”/>
  </xsd:restriction>
</xsd:simpleType>
<xsd:attributeGroup name=“InternalAttrGroup”>
  <xsd:attribute name=“kind” type=“InternalOprType”/>
  <xsd:attribute name=“location” type=“InternalOprLocationType”/>
</xsd:attributeGroup>
<xsd:simpleType name=“InternalOprType”>
  <xsd:restriction base=“xsd:string”>
    <xsd:enumeration value=“&gt;”/>
    <xsd:enumeration value=“&lt;”/>
    <xsd:enumeration value=“&gt;=”/>
    <xsd:enumeration value=“&lt;=”/>
    <xsd:enumeration value=“&gt;&lt;”/>
    <xsd:enumeration value=“=”/>
    <xsd:enumeration value=“+”/>
    <xsd:enumeration value=“−”/>
    <xsd:enumeration value=“*”/>
    <xsd:enumeration value=“/”/>
    <xsd:enumeration value=“%”/>
    <xsd:enumeration value=“(”/>
    <xsd:enumeration value=“)”/>
  </xsd:restriction>
</xsd:simpleType>
<xsd:simpleType name=“InternalOprLocationType”>
  <xsd:restriction base=“xsd:string”>
    <xsd:enumeration value=“prefix”/>
    <xsd:enumeration value=“infix”/>
    <xsd:enumeration value=“postfix”/>
  </xsd:restriction>
</xsd:simpleType>
</xsd:schema>
```

The meanings of significant parameters (NAME) used in the XML syntax of the Event condition descriptor (EventConditionDescriptor) of an Event Report Request data are as follows.

A parameter “EventConditionDescriptor” specifies a condition for determining that an Event occurs, and it can be represented by combining a plurality of conditions.

A parameter “EventConditionGroup,” which is a group for specifying an Event, is largely formed of a timing-based condition, a condition based on the use of a digital item, and a peer operation-based condition.

A parameter “TimeCondition,” which is a timing-based condition, is formed of operators that represent a relationship between a timing Event and an Event.

A parameter “DIOperationCondition,” which is an operation condition related to the peer's use of a digital item, is formed of operators that represent a relationship between an operation Event and an Event.

A parameter “PeerCondition,” which is related to an Event other than an Event that occurs by the timing-based condition and the condition based on the use of a digital item, describes information related to peer operation or peer device, and it is formed of operators that represent a relationship between a condition and an Event.

A parameter “TimeEvent” includes “SpecificTime,” “ElapsedTime,” and “PeriodicTime.”

A parameter “DIOperation” describes the peer's use of a digital item, and it is represented in terms, e.g., play, move, delete, copy and stop.

A parameter “PeerEvent” describes conditions related to peer operation or peer device status, and it is formed of operators that represent a condition status and a relationship between the name and value of the condition. For example, NetworkCongestion>=0.8.

A parameter “ExternalOperator” is an operator that represents a relationship between conditions, and it includes the kinds of operators, such as logical operators and parenthesis and location of an operator.

A parameter “InternalOperator” is an operator that represents a relationship between the name of a condition and a value within a peer Event, and it is formed of the kind of an operator, e.g., arithmetic operator and comparison operator, and the location of the operator.

A parameter “Kind” names the kinds of operators and a parameter “location” indicates the location of an operator. An operator can be a prefix, infix or postfix.

Hereafter, an Event Report data of the present invention will be described more in detail.

FIG. 13 is a diagram showing an Event Report data in accordance with an embodiment of the present invention.

As shown in FIG. 13, the Event Report data of the present invention includes an Event Report descriptor (ERDescriptor) for describing information related to creation and transmission of an Event Report data, an original Event Report Request (OriginalERR) data for describing reference to an Event Report Request data that has requested to generate the Event Report data, and an Event Report data (ERData) which is a payload including Event Report data. Additionally, it includes an embedded Event Report Request (embeddedERR) data which is another Event Report Request data or another Event Report data that can be included in the Event Report data.

The following XML syntax defines an Event Report data in accordance with an embodiment of the present invention.

```
<xsd:element name=“ER” type=“erl:ERType”/>
<xsd:complexType name=“ERType”>
<xsd:sequence>
  <xsd:element ref=“erl:ERDescriptorofERType”/>
  <xsd:element ref=“erl:OriginalERR”/>
  <xsd:element ref=“erl:ERData”/>
  <xsd:element name=“embeddedERR” type=“erl:ERRType”
minOccurs=“0”/>
</xsd:sequence>
</xsd:complexType>
```

Hereinafter, the elements of the Event Report data will be described individually.

The following XML syntax defines an Event Report descriptor (ERDescriptor) of an Event Report data in accordance with an embodiment of the present invention.

```
<!-- ######################################## -->
<!--  Definition of Event Report Descriptor  -->
<!-- ######################################## -->
<xsd:element name=“ERDescriptor”>
<xsd:complexType>
  <xsd:sequence>
    <xsd:element name=“Description” type=“xsd:string” minOccurs=“0”/>
    <xsd:element name=“Status” type=“xsd:Boolean”/>
    <xsd:element name=“Creation” type=“erl:CreationType”/>
  </xsd:sequence>
</xsd:complexType>
</xsd:element>
```

The Event Report Request descriptor (ERDescriptor) of the Event Report data is an element that describes information related to occurrence and delivery of an Event Report data, and it includes “Description,” “Status,” and “Creation” as shown in the above XML syntax. The “Creation” has the same grammar and meaning as “CreationType” among the above-described “HistoryType.”

The elements of the Event Report Request descriptor (ERDescriptor) will be described more in detail.

The “Description” is an element having a free form that can describe information related to the Event Report data, and the “Status” is an element that shows whether the Event Report data is generated and transmitted normally. The “Creation” is an element for describing information related to generation of an Event Report data.

The following XML syntax defines an original Event Report Request (OriginalERR) data in accordance with an embodiment of the present invention.

<!-- ############################################ -->
<!-- Definition of OriginalERR datatype -->
<!-- ############################################ -->
<xsd:element name=“OriginalERR” type=“dii:identifier”/>

Meanwhile, the embedded Event Report Request (EmbeddedERR) data of an Event Report data can be included in an Event Report data for the purpose of acknowledgement or forwarding in the present invention.

The method of the present invention can be embodied as a program and stored in a computer-readable recording medium, e.g., CD-ROMs, RAMs, and ROMs, floppy disks, hard disks, and magneto-optical disks.

While the present invention has been described with respect to certain preferred embodiments, it will be apparent to those skilled in the art that various changes and modifications may be made without departing from the scope of the invention as defined in the following claims.

What is claimed is:

1. An Event Reporting system for requesting and processing a report on an Event that occurs upon a use of a digital item, comprising:
an Event Report Request data processing means for creating an Event Report Request data which requests a report on an Event Report data; and
an Event Report data processing means for creating and transmitting an Event request in response to the Event Report Request data transmitted from the Event Report Request data processing means to perform an Event Reporting.

2. The system as recited in claim 1, wherein the Event Report Request data processing means includes:
an Event Report Request data creating means for creating an Event Report Request data;
an Event Report Request data transmitting means for transmitting the Event Report Request data created in the Event Report Request data creating means;
an Event Report Request data receiving means for receiving the Event Report Request data;
an Event Report Request data analyzing means for analyzing the Event Report Request data received in the Event Report Request data receiving means; and
a monitoring means for monitoring whether or not an Event occurs.

3. The system as recited in claim 1, wherein the Event Report data processing means includes:
an Event Report data creating means for creating an Event Report data;
an Event Report data transmitting means for transmitting the Event Report data created in the Event Report data creating means;
an Event Report data receiving means for receiving the Event Report data; and
an Event Report data analyzing means for analyzing the Event Report data received in the Event Report data receiving means.

4. The system as recited in claim 3, wherein the Event Report Request data includes:
a descriptor for describing characteristics of the Event Report Request data;
an Event Report descriptor for describing characteristics that an Event Report data to be generated by the current Event Report Request data should have and Event Report data; and
an Event condition descriptor for specifying and describing conditions which becomes a standard for occurrence of an Event.

5. The system as recited in claim 4, wherein the descriptor includes:
lifetime indicating remaining lifetime of the Event Report Request data;
history indicating information on history of creating or modifying the Event Report Request data or the Event Report data; and
priority indicating a priority order of processing Event Report Request data.

6. The system as recited in claim 5, wherein the lifetime includes:
a starting time of valid lifetime of the Event Report Request data; and
an ending time of the valid lifetime of the Event Report Request data.

7. The system as recited in claim 5, wherein the history includes:
creation information for describing a history of creating an Event Report Request data or a Event Report data; and
modification information for modifying a history of modifying an Event Report Request data or a Event Report data.

8. The system as recited in claim 7, wherein the history includes:
peer information which is a unique identifier of a peer that performs creation or modification;
user information which is a unique identifier of a user that performs creation or modification;
time information at which an Event Report Request data or an Event Report data is created or modified; and
description information for indicating operation of the peer that creates or modifies the Event Report Request data or Event Report data.

9. The system as recited in claim 5, wherein the priority has a value from 0 to 5 and the lower the number is, the higher the priority is.

10. The system as recited in claim 9, wherein, if a priority level is not specified, the priority is considered to have a priority of a level 2.

11. The system as recited in claim 4, wherein the ER descriptor includes:
identification information of the Event Report data;
access control information for describing a peer or a user that can access to the Event Report data;
Event Report data for describing report data requested by the Event Report Request data;
an embedded Event Report Request data for indicating another Event Report Request data which is enclosed for acknowledgement or forwarding; and
transmission parameters for describing information related to transmission of the Event Report data.

12. The system as recited in claim 11, wherein the Event Report data includes at least one among a peer, a user, a reference digital item (RefDI) and location.

13. The system as recited in claim 11, wherein the Event Report data include:
peer identification information for creating an Event Report data;
user identification information for creating an Event Report data;
time information when the Event occurs;
location information of the peer;
identification information of a digital item which is an object of Event occurrence;
digital item identification information related to the current Event Report data; and
operation information describing operations related to the use of a digital item.

14. The system as recited in claim 11, wherein the transmission parameters include:
receiver information to whom the Event Report data is transmitted; and
transmission time information describing time at which the Event Report data is authored and transmitted.

15. The system as recited in claim 14, wherein the transmission time information includes specific time information at which the Event Report data is to be transmitted, elapsed time information, and periodic time information.

16. The system as recited in claim 15, wherein the specific time information includes information requesting to transmit the Event Report data at least one time among at a specific time, after the specific time, and between specific time and time.

17. The system as recited in claim 15, wherein the elapsed time information requests to transmit the Event Report data at least one time among at an elapsed time, before the elapsed time, and between elapsed time and time.

18. The system as recited in claim 15, wherein the periodic time information includes:
a starting time of periodic transmission;
an interval time between periods;
a period continuing time; and
an ending time of the periodic transmission.

19. The system as recited in claim 4, wherein the Event condition descriptor includes:
a timing-based condition for describing time on the peer's part where an Event occurs based on time when an Event Report Request data is received;
a digital item usage-based condition for describing an Event that occurs in connection with use of a digital item; and
a peer operation-based condition for describing an Event regardless of the use of the digital item.

20. The system as recited in claim 19, wherein the timing-based condition includes specific time, elapsed time and periodic time.

21. The system as recited in claim 19, wherein the digital item usage-based condition uses terms defined in ISO/IEC 21000-6 Rights Data Dictionary (RDD).

22. The system as recited in claim 19, wherein the peer operation-based condition describes the operation of a peer or a status of a device.

23. The system as recited in claim 19, wherein the Event condition descriptor is expressed by a combination of conditions.

24. The system as recited in claim 23, wherein the combination of conditions uses external operators and internal operators stated in Tables 1 and 2, which are shown as:
TABLE 1

| | |
|---|---|
| Logical Operator | AND, OR, XOR, NOT |
| Parentheses | (,) |
| Location | PREFIX, POTFIX |

TABLE 2

| | |
|---|---|
| Comparison Operator | =, <, >, <=, <>, >, >= |
| Arithmetic Operator | +, −, *, /, %, \hat{ } |
| Location | PREFIX, INFIX, POSTFIX |

25. The system as recited in claim 19, wherein the timing-based condition is formed of operators expressing a relationship between a timing Event and an Event;
the digital item usage-based condition is formed of operators expressing a relationship between an operation Event and an Event; and
the peer operation-based condition is formed of operators expressing a relationship between an condition and an Event.

26. The system as recited in claim 3, wherein the Event Report data includes:
an Event Report descriptor for describing information related to creation and transmission of the Event Report data;
an original Event Report Request data for describing a reference for the Event Report Request data which makes the Event Report data to be created; and
an Event Report data including report data of the Event Report data.

27. The system as recited in claim 26, wherein the Event Report data further includes an embedded Event Report Request data for describing another Event Report Request data or another Event Report data which is enclosed to the Event Report data for acknowledgement or forwarding.

28. The system as recited in claim 27, wherein the Event Report descriptor includes:
description for describing other data related to the Event Report data in a free form;
status information for describing whether the Event Report data is created and transmitted normally; and
creation information for describing information related to creation of the Event Report data.

29. An apparatus for requesting a report for an Event that occurs upon a use of a digital item to perform Event Reporting, comprising:
an Event Report Request data creating means for creating an Event Report Request data in response to an Event Report Request data requested and received by a user;
an Event Report Request data transmitting means for transmitting the Event Report Request data created in the Event Report Request data creating means;
an Event Report Request data receiving means for receiving the Event Report Request data;
an Event Report Request data analyzing means for analyzing the Event Report Request data received in the Event Report Request data receiving means; and
a monitoring means for monitoring whether or not an Event occurs.

30. The apparatus as recited in claim 29, wherein the Event Report Request data includes:
a descriptor for describing characteristics of the Event Report Request data;
an Event Report descriptor for describing characteristics that an Event Report data to be generated by the current Event Report Request data should have and Event Report data; and
an Event condition descriptor for specifying and describing conditions which becomes a standard for occurrence of an Event.

31. The apparatus as recited in claim 30, wherein the descriptor includes:
lifetime indicating remaining lifetime of the Event Report Request data;
history indicating information on history of creating or modifying the Event Report Request data or the Event Report data; and
priority indicating a priority order of processing Event Report Request data.

32. The apparatus as recited in claim 30, wherein the Event Report descriptor includes:
identification information of the Event Report data;
access control information for describing a peer or a user that can access to the Event Report data;
Event Report data for describing report data requested by the Event Report Request data;
an embedded Event Report Request data for indicating another Event Report Request data which is enclosed for acknowledgement or forwarding; and
transmission parameters for describing information related to transmission of the Event Report data.

33. The apparatus as recited in claim 30, wherein the Event condition descriptor includes:
a timing-based condition for describing time on the peer's part where an Event occurs based on time when an Event Report Request data is received;
a digital item usage-based condition for describing an Event that occurs in connection with the use of a digital item; and
a peer operation-based condition for describing an Event that occurs regardless of the use of the digital item.

34. The apparatus as recited in claim 29, wherein the Event Report data includes:
an Event Report descriptor for describing information related to creation and transmission of the Event Report data;
an original Event Report Request data for describing a reference for the Event Report Request data which makes the Event Report data to be created; and
Event Report data including report data of the Event Report data.

35. The apparatus as recited in claim 34, wherein the Event Report data further includes an embedded Event Report Request data for describing another Event Report Request data or another Event Report data which is enclosed to the Event Report data for acknowledgement or forwarding.

36. The apparatus as recited in claim 34, wherein the Event Report descriptor includes:
description for describing other data related to the Event Report data in a free form;
status information for describing whether the Event Report data is created and transmitted normally; and
creation information for describing information related to creation of the Event Report data.

37. An apparatus for reporting an Event that occurs upon a use of a digital item to perform Event Reporting, comprising:
an Event Report data creating means for creating an Event Report data;
an Event Report Request data transmitting means for transmitting the Event Report Request data created in the Event Report Request data creating means;
an Event Report data receiving means for receiving the Event Report data; and
an analyzing means for analyzing the Event Report data received in the Event Report data receiving means.

38. The apparatus as recited in claim 37, wherein the Event Report data includes:
an Event Report descriptor for describing information related to creation and transmission of the Event Report data;
an original Event Report Request data for describing a reference for the Event Report Request data which makes the Event Report data to be created; and
an Event Report data including report information of the Event Report data.

39. The apparatus as recited in claim 38, wherein the Event Report data further includes an embedded Event Report Request data for describing another Event Report Request data or another Event Report data which is enclosed to the Event Report data for acknowledgement or forwarding.

40. The apparatus as recited in claim 38, wherein the Event Report descriptor includes:
description for describing other data related to the Event Report data in a free form;
status information for describing whether the Event Report data is created and transmitted normally; and
creation information for describing information related to creation of the Event Report data.

41. A method for reporting an Event that occurs upon a use of a digital item to perform Event Reporting, comprising:
a) an Event Report Request data processing step of creating and transmitting an Event Report Request data requesting a report on an Event, and receiving, analyzing and transmitting an Event Report Request data from outside and monitoring an Event corresponding to the Event Report Request data; and
b) an Event Report data processing step of creating and transmitting the Event Report data created to perform Event Reporting corresponding to the transmitted Event Report Request data, and analyzing and transmitting the Event Report data transmitted from outside.

42. The method as recited in claim 41, wherein the a) Event Report Request data processing step includes the steps of:
a1) creating the Event Report Request data;
a2) transmitting the Event Report Request data;
a3) receiving the Event Report Request data;
a4) analyzing the Event Report Request data; and
a5) monitoring whether or not an Event occurs.

43. The method as recited in claim 41, wherein the b) Event Report data processing step includes the steps of:
b1) generating the Event Report data;
b2) transmitting the Event Report data;
b3) receiving the Event Report data; and
b4) analyzing the Event Report data.

44. The method as recited in claim 41, wherein the Event Report Request data includes:
a descriptor for describing characteristics of the Event Report Request data;
an Event Report descriptor for describing characteristics that an Event Report data to be generated by the current Event Report Request data should have and Event Report data; and
an Event condition descriptor for specifying and describing conditions which becomes a standard for occurrence of an Event.

45. The method as recited in claim 44, wherein the descriptor includes:
lifetime indicating remaining lifetime of the Event Report Request data;
history indicating information on history of creating or modifying the Event Report Request data or the Event Report data; and
priority indicating a priority order of processing Event Report Request data.

46. The method as recited in claim 44, wherein the Event Report descriptor includes:
identification information of the Event Report data;
access control information for describing a peer or a user that can access to the Event Report data;
Event Report data for describing report data requested by the Event Report Request data;
an embedded Event Report Request data for indicating another Event Report Request data which is enclosed for acknowledgement or forwarding; and
transmission parameters for describing information related to transmission of the Event Report data.

47. The method as recited in claim 44, wherein the Event condition descriptor includes:
a timing-based condition for describing time on the peer's part where an Event occurs based on time when an Event Report Request data is received;
a digital item usage-based condition for describing an Event that occurs in connection with the use of a digital item; and
a peer operation-based condition for describing an Event regardless of the use of the digital item.

48. The method as recited in claim 41, wherein the Event Report data includes:
an Event Report descriptor for describing information related to creation and transmission of the Event Report data;
an original Event Report Request data for describing a reference for the Event Report Request data which makes the Event Report data created; and
an Event Report data including report information of the Event Report data.

49. The method as recited in claim 48, wherein the Event Report data further includes an embedded Event Report Request data for describing another Event Report Request data or another Event Report data which is enclosed to the Event Report data for acknowledgement or forwarding.

50. The method as recited in claim 49, wherein the Event Report descriptor includes:
description for describing other data related to the Event Report data in a free form;
status information for describing whether the Event Report data is created and transmitted normally; and
creation information for describing information related to creation of the Event Report data.

51. An Event Report Request data which is used for requesting a report on an Event that occurs upon a use of a digital item to perform Event Reporting, comprising:
a descriptor for describing characteristics of the Event Report Request data;
an Event Report descriptor for describing characteristics that an Event Report data to be generated by the current Event Report Request data should have and Event Report data; and
an Event condition descriptor for specifying and describing conditions which become a standard for occurrence of an Event.

52. The Event Report Request data as recited in claim 51, wherein the descriptor includes:
lifetime indicating remaining lifetime of the Event Report Request data;
history indicating information on history of creating or modifying the Event Report Request data or the Event Report data; and
priority indicating a priority order of processing Event Report Request data.

53. The Event Report Request data as recited in claim 51, wherein the Event Report descriptor includes:
identification information of the Event Report data;
access control information for describing a peer or a user that can access to the Event Report data;
Event Report data for describing report data requested by the Event Report Request data;
an embedded Event Report Request data for indicating another Event Report Request data which is enclosed for acknowledgement or forwarding; and
transmission parameters for describing information related to transmission of the Event Report data.

54. The Event Report Request data as recited in claim 51, wherein the Event condition descriptor includes:
a timing-based condition for describing time on the peer's part where an Event occurs based on time when an Event Report Request data is received;
a digital item usage-based condition for describing an Event that occurs in connection with use of a digital item; and
a peer operation-based condition for describing an Event regardless of the use of the digital item.

55. An Event Report data which is used to provide information corresponding to an Event Report Request data to perform Event Reporting on an Event that occurs upon a use of a digital item, comprising:
an Event Report descriptor for describing information related to creation and transmission of the Event Report data;
an original Event Report Request data for describing a reference for the Event Report Request data which makes the Event Report data created; and
an Event Report data including report information of the Event Report data.

56. The Event Report data as recited in claim 55, wherein the Event Report data further includes an embedded Event Report Request data for describing another Event Report Request data or another Event Report data which is enclosed to the Event Report data for acknowledgement or forwarding.

57. The Event Report data as recited in claim 55, wherein the Event Report descriptor includes:
description for describing other data related to the Event Report data in a free form;
status information for describing whether the Event Report data is created and transmitted normally; and
creation information for describing information related to creation of the Event Report data.

58. A computer-readable recording medium for recording a program that implements an Event Reporting method in a system for requesting and processing a report on an Event that occurs upon a use of a digital item, the method comprising the steps of:
a) creating and transmitting an Event Report Request data requesting a report on an Event, and receiving, analyzing and transmitting an Event Report Request data from outside, and monitoring an Event corresponding to the Event Report Request data; and
b) creating and transmitting the Event Report data created to perform Event Reporting corresponding to the transmitted Event Report Request data, and analyzing and transmitting the Event Report data transmitted from outside.
